(19) United States
(12) Patent Application Publication
(10) Pub. No.: US 2025/0026484 A1
(43) Pub. Date: Jan. 23, 2025

(54) MODULE FOR AIRCRAFT COMPRISING A DIHYDROGEN PROCESSING SYSTEM

(71) Applicant: Airbus Operations SAS, TOULOUSE (FR)

(72) Inventors: Jérôme MILLIERE, TOULOUSE (FR); Lionel CZAPLA, TOULOUSE (FR); Romain JOUBERT, TOULOUSE (FR)

(21) Appl. No.: 18/776,574

(22) Filed: Jul. 18, 2024

(30) Foreign Application Priority Data
Jul. 20, 2023 (FR) 2307799

(51) Int. Cl. B64D 37/32; B64D 37/16; B64D 37/30

(52) U.S. Cl. CPC B64D 37/32; B64D 37/16; B64D 37/30

(57) ABSTRACT

A module for an aircraft, the module comprising a sealed housing comprising walls delimiting an interior volume, a processing system to process dihydrogen and fixed on the inside of the housing, an inlet port connected to the interior volume and equipped with a first shut-off valve, an outlet port connected to the interior volume and equipped with a second shut-off valve and beads filling the interior volume.

### CROSS-REFERENCES TO RELATED APPLICATIONS

This application claims the benefit of French Patent Application Number 2307799 filed on Jul. 20, 2023, the entire disclosure of which is incorporated herein by way of reference.

### FIELD OF THE INVENTION

The present invention relates to a module comprising a housing in which is housed a processing system for dihydrogen for supplying an aircraft engine and in which the housing is filled with beads, a method for filling the module, as well as an aircraft comprising at least one module of this kind.

### BACKGROUND OF THE INVENTION

In order to reduce emissions of carbon dioxide (CO₂) from aircraft engines, it is known in the art for dihydrogen to be used as fuel. The aircraft then comprises a dihydrogen tank and at least one engine powered by said dihydrogen through pipelines running in the aircraft between the tank and each engine and on which dihydrogen processing systems such as pumps, heaters and valves are installed.

Safety must be ensured if an incident occurs on the supply line between the tank and the engine. For this purpose, it is known in the art for various safety systems to be installed.

Although an arrangement of this kind is effective, it is desirable to limit the volume of dihydrogen that escapes in the event of an incident.

### SUMMARY OF THE INVENTION

An object of the present invention is to propose an aircraft module comprising a housing in which is arranged a dihydrogen processing system, wherein said housing is filled with beads allowing the space available for dihydrogen to be reduced in the event of a leak.

To this end, a module for an aircraft is proposed, said module comprising:
a sealed housing comprising walls delimiting an interior volume,
a processing system intended to process dihydrogen fixed on the inside of said housing,
an inlet port fluidically connected to said interior volume and equipped with a first shut-off valve,
an outlet port fluidically connected to said interior volume and equipped with a second shut-off valve and
beads filling the interior volume.

The presence of beads means that the space available for dihydrogen in the event of a leak inside the housing is reduced which limits the amount of dihydrogen that can be present in said housing.

Advantageously, the module comprises a membrane arranged in the interior volume and fixed to the walls on one side of the processing system, delimiting the interior volume into a first sub-volume and a second sub-volume in which the processing system is arranged, wherein the inlet port opens out directly into the first sub-volume and the outlet port opens out directly into the first sub-volume.

Advantageously, the module comprises a suction port fluidically connected to the second volume and equipped with a third shut-off valve.

Advantageously, the membrane and the fixing thereof to the walls are sealed. Advantageously, the beads are sealed.

Advantageously, the beads are glass beads.

The invention also proposes a method for filling a module according to any one of the preceding variants, wherein the method comprises the steps of:
providing the housing without beads,
opening the first shut-off valve and the second shut-off valve and the third shut-off valve when present,
introducing beads through the inlet port until the housing is filled,
stopping the introduction of the beads and
closing the first shut-off valve and the second shut-off valve and the third shut-off valve when present.

Advantageously, the outlet port and the suction port (230), when present, are fluidically connected to a vacuum pump.

The invention also proposes an aircraft comprising a dihydrogen tank, an engine and at least one module according to any one of the preceding variants fluidically connected between the tank and the engine.

### BRIEF DESCRIPTION OF THE DRAWINGS

The features of the invention mentioned above, as well as others, will become clearer upon reading the following description of an exemplary embodiment, said description being made in relation to the attached drawings, among which:

FIG. 1 is a side view of an aircraft according to the invention,

FIG. 2 is a schematic and sectional representation of a module according to a first embodiment of the invention,

FIG. 3 is a schematic and sectional representation of a module according to a second embodiment of the invention and

FIG. 4 is an exploded view of the module in FIG. 3.

### DETAILED DESCRIPTION OF THE PREFERRED EMBODIMENTS

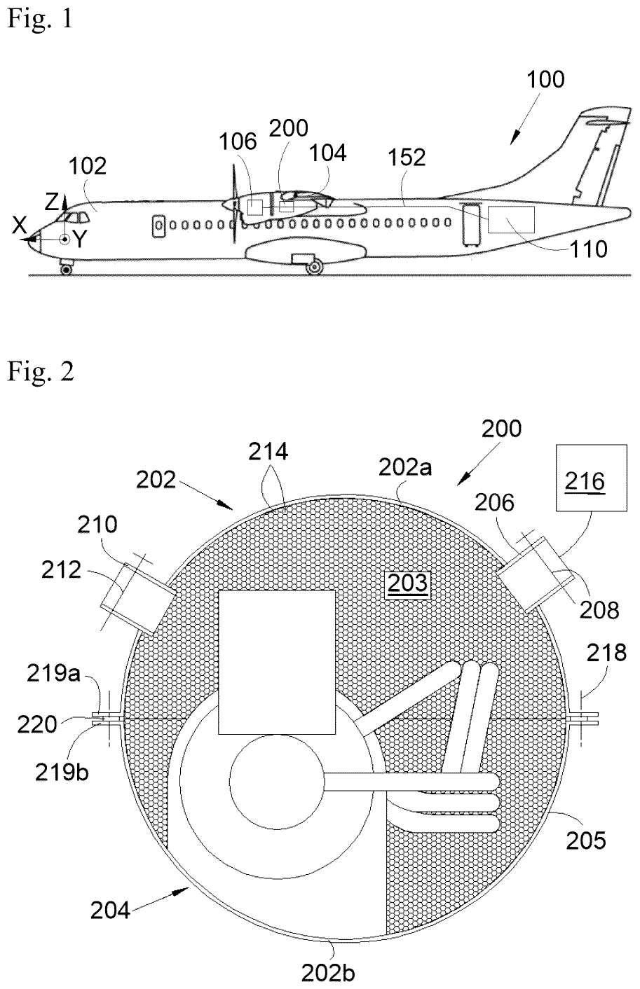

In the following description, terms related to a position are referenced to an aircraft in a normal flight position, that is, as shown in FIG. 1.

In the following description, and by convention, X refers to the longitudinal direction of the aircraft, Y refers to the transverse direction which is horizontal when the aircraft is on the ground and Z refers to the vertical direction which is vertical when the aircraft is on the ground, these three directions X, Y and Z being orthogonal to one another.

FIG. 1 shows an aircraft 100 which comprises a fuselage 102 on each side of which a wing 104 is fixed which carries at least one engine 106 operating with dihydrogen as the fuel. In the embodiment of the invention presented in FIG. 1, the engine 106 is a propeller engine, for example an electric motor powered by a dihydrogen fuel cell, but any other type of engine is conceivable.

Arrow F indicates the forward direction of the aircraft 100.

The aircraft 100 comprises at least one tank 110 in which dihydrogen is stored, preferably in liquid form. In the embodiment of the invention, the tank 110 is arranged at the rear of the fuselage 102, but a different positioning is possible. The aircraft 100 also comprises at least one module 200 which is fluidically connected between the tank 1010 and the engine 106, in particular by means of a main pipeline 152 which is itself fluidically connected between the tank 110 and the engine 106 to be supplied.

The module 200 is mounted in a sealed manner on the main pipeline 152, meaning that the main pipeline 152 passes through the module 200 from one side to the other. In the embodiment of the invention presented in FIG. 1, there is only one module 200 but there may be several others arranged one after the other along the main pipeline 152.

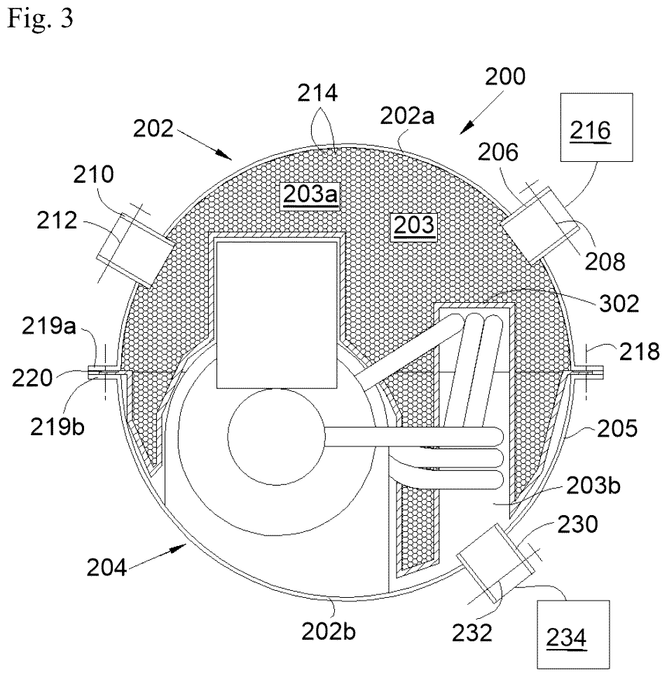

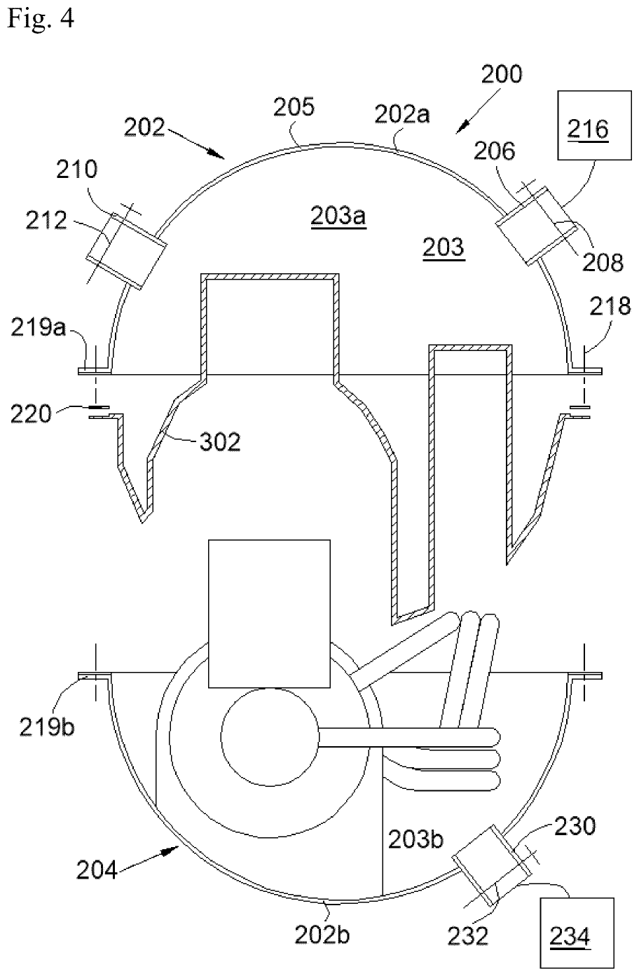

FIG. 2 shows the module 200 according to a first embodiment of the invention and FIGS. 3 and 4 show the module 200 according to a second embodiment of the invention.

In the first and second embodiments, the module 200 comprises a housing 202 which comprises walls 205 delimiting an interior volume 203. The housing 202 is sealed to prevent dihydrogen present in the housing 202 from spreading outside the housing 202.

The main pipeline 152 passes through one of the walls 205 coming from the tank 110 and through one of the walls 205 to reach the engine 106. The passage through each wall 205 of the main pipeline 152 is made in a sealed manner using appropriate means known to a person skilled in the art.

The module 200 also comprises a processing system 204 that processes the dihydrogen flowing in the main pipeline 152 passing through the housing 202. A processing system 204 of this kind is, for example, a pump, a heater or a valve, or other things, or a set of several of these components.

The processing system 204 is fixed inside the housing 202, in particular by being fixed to the walls 205 by any appropriate fixing means, such as screw-nut systems, rivets, etc.

Placing the processing system 204 in the housing 202 allows the dihydrogen to be contained in the housing 202 in the event of a leak at the processing system 204.

The housing 202 is filled at least in part with beads 214, in particular glass beads with a diameter of about 30 to 125 micrometers. Each bead 214 is preferably sealed to prevent dihydrogen from entering it.

The beads 214 thereby fill the interior volume 203 around the processing system 204 and, depending on the degree of filling of the interior volume 203, the space remaining for dihydrogen in the event of a leak is reduced by the same amount.

To allow the filling of the housing 202 with the beads 214, the module 200 comprises an inlet port 210 fluidically connected to the interior volume 203 through a wall 205. To allow or prevent the passage of the beads 214, the inlet port 210 is equipped with a first shut-off valve 212 which can therefore be manipulated between an open position, in which the beads 214 can pass through the inlet port 210, and a closed position, in which the beads 214 cannot pass through the inlet port 210.

To allow the air present in the housing 202 to escape during the filling of the housing 202 with the beads 214, the module 200 comprises an outlet port 206 fluidically connected to the interior volume 203 through a wall 205. To allow or prevent the passage of air, the outlet port 206 is equipped with a second shut-off valve 208 which can therefore be manipulated between an open position, in which air can pass through the outlet port 206, and a closed position, in which air cannot pass through the outlet port 206.

With an arrangement of this kind, it is therefore easy to fill the housing 202 with beads 214 limiting the volume available for dihydrogen in the event of a leak.

To ensure the seal of the housing 202, the shut-off valves 208 and 212 are airtight and hydrogen-tight in the closed position.

In the second embodiment of the invention, the module 200 further comprises a membrane 302 which is disposed in the interior volume 203 and fixed to the walls 205.

The membrane 302 is arranged so as to be on one side of the processing system 204 and it delimits the interior volume 203 into a first sub-volume 203a on one side of the membrane 302 and a second sub-volume 203b on the other side of the membrane 302.

The processing system 204 is arranged in the second sub-volume 203b.

The inlet port 210 opens out directly into the first sub-volume 203a and the outlet port 206 opens out directly into the first volume 203a.

In the second embodiment of the invention, the module 200 further comprises a suction port 230 fluidically connected to the second volume 203b through a wall 205. To allow or prevent the passage of air, the suction port 230 is equipped with a third shut-off valve 232 which can therefore be manipulated between an open position, in which air can pass through the suction port 230, and a closed position, in which air cannot pass through the suction port 230.

To help the beads 214 occupy as much space as possible and thereby remove the air present in the second volume 203b, it is possible to create an artificial vacuum in said second volume 203b by fluidically connecting the suction port 230 to a vacuum pump 234.

The installation of a membrane 302 allows the beads 214 of the processing system 204 to be separated. In fact, due to the construction, the beads 214 will fill the first sub-volume 203a without entering the second sub-volume 203b.

The flexibility of the membrane 302 allows it to best match the shape of the processing system 204.

In both embodiments, a method of filling the module 200 comprises the steps of:
providing the housing 202 without beads 214 and filled with air,
opening the first shut-off valve 208 and the second shut-off valve 212,
introducing the beads 214 through the inlet port 210 until the housing 202 is filled, in particular to the desired filling degree, and during which the air present in the housing 202 is evacuated through the outlet port 206,
stopping the introduction of the beads 214, and
closing the first shut-off valve 208 and the second shut-off valve 212 to close the housing 202 in a sealed manner.

A reverse procedure can be implemented, in order to remove the beads 214.

Air leaves the housing 202 naturally, due to the fact that the beads 214 gradually occupy the interior volume 203. To help the beads 214 occupy as much space as possible, it is possible to create an artificial vacuum in the housing 202 by fluidically connecting the outlet port 206 to a vacuum pump 216.

In the first embodiment, the outlet port 206 is arranged so that the beads 214 cannot leave through said outlet port 206, for example by fitting a filter.

In the second embodiment, as specified earlier, the membrane 302 is sucked by the vacuum pump 234 and is pressed against the processing system 204. To ensure that the vacuum does not spread to the first sub-volume 203a, the membrane 302 and its fixing to the walls 205 are sealed.

The vacuum pump 234 is connected to the suction port 230 before the opening of the third shut-off valve 232 and is disconnected from the suction port 230 after the closing of the third shut-off valve 232.

The step of initiating the filling process then also involves opening the third shut-off valve 232 and the step of ending the filling process then also involves closing the third shut-off valve 232.

In the embodiment of the invention presented in FIGS. 2 to 4, the housing 202 is made up of two shells 202a-b, wherein in this case they both carry the inlet port 210 and the outlet port 206 and wherein the other carries the processing system 204 and the suction port 230. The two shells 202a-b are fixed in a sealing manner to one another by any appropriate fixing means 218, such as screw-nut systems, rivets, etc.

In the embodiment of the invention presented here, each shell 202a-b has a flange 219a-b extending around the perimeter of the shell 202a-b and is opposite the flange 219b-a of the other shell 202b-a and the fixing means 218 fix the flanges 219a-b together.

To guarantee the seal between the two shells 202a-b, a gasket 220 is arranged between them and, more specifically in this case, between the flanges 219a-b.

In the embodiment of the invention presented in FIGS. 3 and 4, the membrane 302 is also disposed between the flanges 219a-b with the gasket 220.

In another embodiment which is not shown, the membrane 302 can be glued to the inside face of the walls 205 and, more specifically in this case, to the inside face of the shell 202b carrying the suction port 230.

In the second embodiment of the invention with the two shells 202a-b, the step of providing a module 200 with an empty housing 202 may include providing the two shells 202a-b separately, arranging and fixing the membrane 302 and the gasket 220 and fixing the two shells 202a-b to one another in a sealed manner.

The installation and fixing of the membrane 302 and the gasket 220 include, for example, of placing them between the two shells 202a-b before fixing the shells 202a-b together, or fixing the membrane 302 inside the shell 202b carrying the suction port 230 and the gasket 220 between the two shells 202a-b before fixing the shells 202a-b together.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A module for an aircraft, said module comprising:
a sealed housing comprising walls delimiting an interior volume,
a processing system configured to process dihydrogen, the processing system fixed on an inside of said housing,
an inlet port fluidically connected to said interior volume and equipped with a first shut-off valve,
an outlet port fluidically connected to said interior volume and equipped with a second shut-off valve, and
a plurality of beads filling the interior volume.

2. The module according to claim 1, further comprising:
a membrane arranged in the interior volume and fixed to the walls on one side of the processing system and delimiting the interior volume into a first sub-volume and a second sub-volume in which the processing system is arranged,
wherein the inlet port opens out directly into the first sub-volume and the outlet port opens out directly into the first sub-volume.

3. The module according to claim 2, further comprising:
a suction port fluidically connected to the second sub-volume and equipped with a third shut-off valve.

4. The module according to claim 2, wherein the membrane and the fixing thereof to the walls are sealed.

5. The module according to claim 1, wherein the beads are sealed.

6. The module according to claim 1, wherein the beads are glass beads.

7. A method for filling the module according to claim 1, wherein the method comprises the steps of:
providing the sealed housing without beads,
opening the first shut-off valve and the second shut-off valve and, optionally a third shut-off valve,
introducing the beads from the plurality of beads through the inlet port until the sealed housing is filled,
stopping the introduction of the beads from the plurality of beads when the housing is filled, and
closing the first shut-off valve and the second shut-off valve and, optionally the third shut-off valve.

8. The method according to claim 7, wherein the outlet port, and optionally a suction port, are fluidically connected to a vacuum pump.

9. An aircraft comprising:
a dihydrogen tank,
an engine, and
at least one module according to claim 1, the at least one module fluidically connected between the tank and the engine.
